(19) United States
(12) Patent Application Publication
(10) Pub. No.: US 2007/0289222 A1
(43) Pub. Date: Dec. 20, 2007

(54) Door assembly for a vehicle, door, and method of assembly of the door

(76) Inventors: Frederic Papi, Troy, MI (US); John Stickney, Rochester, MI (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/818,269

(22) Filed: Jun. 13, 2007

(30) Foreign Application Priority Data
Jun. 14, 2006 (EP) 06380170.8

(51) Int. Cl. B60J 5/04

(52) U.S. Cl. 49/502

(57) ABSTRACT

The door assembly for a motor vehicle comprises a door part and a trim panel (1) configured for attachment to a door part (21, 22) by means of attachment means (4, 5) configured to achieve the attachment by means of two movements, one of these being perpendicular to the other. The assembly comprises a connection system (7, 8, 9) between an opening handle (6) and a latch (3); this connection system comprises two pivotable elements (7, 8) which are coupled to each other when the trim panel is coupled to the door part.

### TECHNICAL FIELD OF THE INVENTION

The invention lies in the field of doors for vehicles.

### BACKGROUND OF THE INVENTION

Motor vehicles usually comprise doors based on a door part, on the inner side of which a trim panel is attached. The door part may comprise a door panel or box, in which the functional elements are installed, as is the case, for instance, of the latch, window regulator system motor, etc. These elements may also be installed or pre-installed on a modular support (which may comprise a type of panel on which the functional elements are installed or pre-installed) and which may be attached to the door shell proper. In these cases, the trim panel may be installed on the modular support and/or on the door shell. In this way, we may talk of a general structure which comprises a first assembly or element (which may be referred to as the “door part”) and which may comprise the door panel or box and/or the modular support, and a second element that comprises the trim panel which is attached to the first element i.e. the door part, which may comprise the door shell and/or the modular support.

In the installation process, the latch (and, optionally, other accessories) is fitted in what in this text is referred to as the “door part” (and which may comprise the modular support and/or the door shell). In the prior art there are systems in which the opening handle is pre-installed in the door part (for example, in the door shell or on the modular support), and others in which the opening handle is pre-installed on the trim panel.

An important aspect of the vehicle door installation process refers to the connection between the latch opening handle and the latch itself (this aspect is especially significant when the opening handle and the latch are not pre-installed on the same element, so they have to be connected up during the assembly process).

When the handle is installed on the trim panel, the connection may be carried out manually: the lower part of the trim panel may be coupled to the door part, leaving a gap between the door part and the trim panel so that the operator may gain access manually from one side or from above to carry out the connection between the handle and the latch by means of the rod or cable conventionally used for this connection.

Systems are also known in which the handle pre-installed on the door part (directly on the door shell or on the modular support). In these cases, the trim panel has a hole through which the opening handle can pass, so that it may be accessible for the operator on the visible side of the trim panel, once this has been installed on the door part.

US-A-2003/0111865 describes a system for installation of an interior opening handle mounted on a trim panel. The system comprises rods that connect the latch with the opening handle. Each rod has two ends, one connected to the door latch and the other set up to receive the connection to the opening handle so as to link up the two elements.

The interior opening handle is disposed on the trim panel. This handle is provided with hook-like elements for coupling to the free ends of the rods.

To carry out the installation, the upper end of the trim panel is connected to the door part and then a simple turning movement of the trim panel is made so that the hook-like elements are connected directly to the free ends of the rods. In this way, the opening handle is connected automatically to the door latch.

U.S. Pat. No. 5,884,434 describes another system of connecting up the opening handle to the door latch. The door shell has an upper opening for housing a support for the automatic connection of the handle to the connecting rods between handle and latch. This support has an area for anchoring the rod which is connected to the latch and an area which is set up to receive an arm of the handle (which is mounted on the trim panel). In this way, when the trim panel is installed on the door part (in this case, on the door shell), the handle is connected automatically to the support which is linked to the rod, attached at one end to this support and at the other to the latch, so that when the handle is actuated, the latch may be released.

U.S. Pat. No. 5,282,657 describes a system for the automatic connection of the interior opening handle in which the handle and rod are connected up directly. To carry out the automatic connection, the handle has an arm with a hook area at its end (for clasping the respective rod).

### DESCRIPTION OF THE INVENTION

The systems described above may prove suitable for certain applications but unsuitable for others, for instance, when the trim panel is attached to the door part with attachment means configured so that the attachment is achieved by hitching, by means of an first movement of approach between the trim panel and the door part and a second movement in a direction substantially perpendicular to the direction of the first movement.

A first aspect of the invention refers to a door assembly for a vehicle, which comprises:

a door part (which may comprise a door panel or box, and/or a modular support, for example, only the door shell or a door shell to which a modular support in coupled in which the functional elements may be pre-installed); and

a trim panel configured for attachment to the door part by attachment means configured so that the trim panel is attached to the door part by means of a first movement of approach (for example, substantially horizontal) between the trim panel and the door part, as far as an initial position of the trim panel in relation to the door part, and a second hitching movement (for example, substantially vertical) as far as a second position of the trim panel in relation to the door part, in which said trim panel is hitched to the door part by said attachment means. The first movement may be a movement in a first direction and the second movement may be a movement in a second direction substantially perpendicular to said first direction, and/or substantially parallel to a general contact surface between the trim panel and the door part.

Furthermore, the assembly comprises a latch coupled to the door part (for example, to the door shell and/or to a modular support) and an opening handle, which is coupled to the trim panel (for example, forming part of a handle module attached to the trim panel).

In addition, the assembly comprises a system of connection between the opening handle and the latch, configured so that the latch may be opened by means of the opening handle. The connection system comprises:

a first pivotable element associated with the opening handle (for example, forming part of a component integrating the handle) so that said first pivotable element may be made to pivot by means of the handle (i.e. by acting on the handle); and

a second pivotable element associated with the door part (for example, connected to the door shell or panel or coupled to a modular support) and coupled to the latch (for example, by means of a rigid or flexible rod, also referred to as a cable) so that the latch may be opened by means of a pivoting of the second pivotable element.

The assembly further comprises means of coupling between said first pivotable element and said second pivotable element. These coupling means are configured so that when the trim panel is in said first position in relation to the door part, the first pivotable element and the second pivotable element are not coupled to each other (so a pivoting of the first pivotable element does not cause the pivoting of the second pivotable element), and when the trim panel is in said second position in relation to the door part, the first pivotable element and the second pivotable element are coupled to each other, so that a pivoting of the first pivotable element causes the pivoting of the second pivotable element. In other words, in this way, once the trim panel is hitched to the door part, the handle can actuate the latch and open it by way of the two pivotable elements.

Thus, an automatic connection may be achieved between the handle and the latch without the need for any additional movement that is carried out in order to hitch the trim panel to the door part from the first position mentioned above. That is to say, it is the case of a structure that facilitates the assembly process.

The coupling means may comprise at least one projecting element (for example, a stem or pin) associated with either said first or second pivotable element, said projecting element being configured to enter into at least a receiving configuration (for example, a hole or channel) matching up with the other in said first pivotable element and second pivotable element.

The reception configuration may have a funnel configuration to facilitate the insertion of the projecting element into the receiving configuration during the second movement.

The projecting element may comprise a threaded stem on a pivotable support, which could constitute or form part of the first or second pivotable element.

Alternatively, the projecting element may be an extension of the pivoting support, so that the pivoting support, including said projecting element, form a single plastic or metallic piece.

The projecting element may form part of the first pivotable element and the receiving configuration may form part of the second pivotable element.

The second pivotable element may be coupled to the latch by means of at least one rod or cable. The second pivotable element may comprise two connecting holes for the rod, so that the rod may be connected selectively to one or other of said connecting holes, depending on whether it is a left-hand door or a right-hand door of the vehicle. This means that the same piece may be used for doors on both sides of the vehicle.

The first pivotable element may comprise a pivotable plate, which forms part of a single unit that includes the handle and which is installed in a pivotable manner around a axis (all these elements may make up the handle module attached to the trim panel).

The second pivotable element may be fitted on a turret (for example, attached to the turret with a screw), which may be an extension from a support plate attached to the door part (for example, coupled to the door shell or forming part of a modular support).

The first pivotable element may be configured to pivot around a first axis, and the second pivotable element may be configured to pivot around a second axis parallel to the first axis. The “second direction” in which the trim panel moves may be substantially parallel to said first axis and to said second axis.

The second direction may be substantially parallel to a general contact surface between the trim panel and the door part, i.e. once the trim panel is in its first position next to the door part, the trim panel may be “slid” in the second direction (for example, “downwards”), something that entails an easy and secure installation.

The door part may consist of a door shell, or it may comprise a modular support attached to a door shell.

The attachment means between the trim panel and the modular support may comprise a plurality of projections on the trim panel (also called “pins”) and matching holes in the door part (for example, in the door shell), and the projections may comprise a first part substantially perpendicular to the surface of the trim panel (corresponding to the support plane on the panel), and a second part substantially parallel to said surface of the trim panel (i.e. it could be a case of projections in the form of an inverted “L”).

Another aspect of the invention refers to a door for a vehicle that comprises an assembly as described above.

Another aspect of the invention refers to a method of installing a door for a vehicle on the basis of an assembly as described above. The method comprises the following steps:

bringing the trim panel up to the door part by means of said first movement in said first direction;

hitching the trim panel to the door part by means of said second movement in said second direction substantially perpendicular to said first position and/or substantially parallel to the contact surface between the trim panel and the door part, so that a coupling takes place between said first pivotable element and said second pivotable element.

### DESCRIPTION OF THE FIGURES

To supplement the description being given and in order to assist a clearer appreciation of the features of the invention, in accordance with preferred example embodiments of same, as an integral part of said description it is accompanied by a set of drawings, wherein for purely informative and non-restrictive purposes there is represented the following:

FIG. 1 shows a general and a close-up view of the inner side (facing the interior of the vehicle) of a door part, in accordance with a possible embodiment of the invention.

FIG. 2 is a general elevational view of the non-visible side (the one which is coupled on the door part) of a trim panel according to a possible embodiment of the invention (in addition, the positions are shown that some elements, associated with the door part, will occupy once the trim panel has been hitched to the door part).

FIG. 3 illustrates diagrammatically the movements of the trim panel during a possible manner of undertaking the installation process.

FIG. 4 illustrates diagrammatically the trim panel from its visible side, i.e. from the facing the interior of the vehicle.

FIGS. 5-7 illustrate diagrammatically the connection system between the opening handle and the latch (FIGS. 5 and 7 reflect this connecting system at two different stages of the installation process).

FIG. 8 reflects diagrammatically a modular support which, in a possible embodiment of the invention, forms part of the door part.

FIGS. 9A and 9B illustrate diagrammatically the connecting system in two different positions or states, corresponding to latch closed (FIG. 9A) and open (FIG. 9B).

### PREFERRED EMBODIMENT OF THE INVENTION

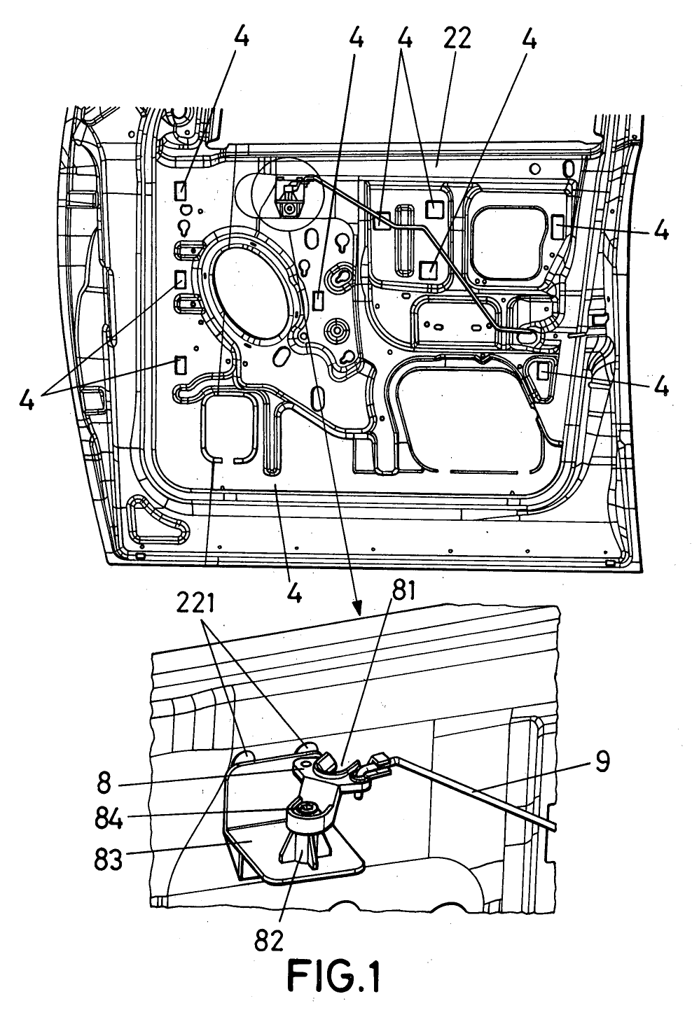

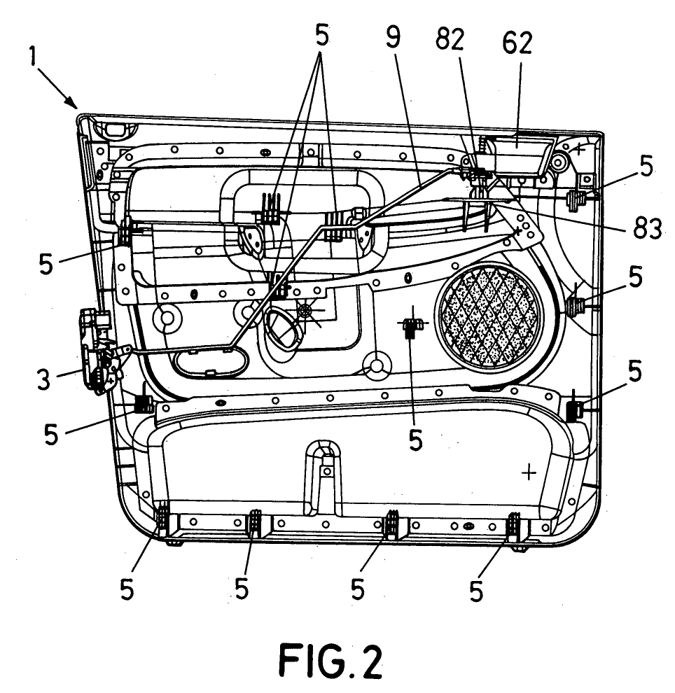

FIG. 1 illustrates a door part which comprises the door panel or box 22, and in which a latch is mounted (not illustrated in FIG. 1 as it is concealed in the interior of the door shell 22; it is illustrated diagrammatically, however, in FIG. 2). The door part may also have other accessories coupled, for example, a window regulator system, speakers, etc.

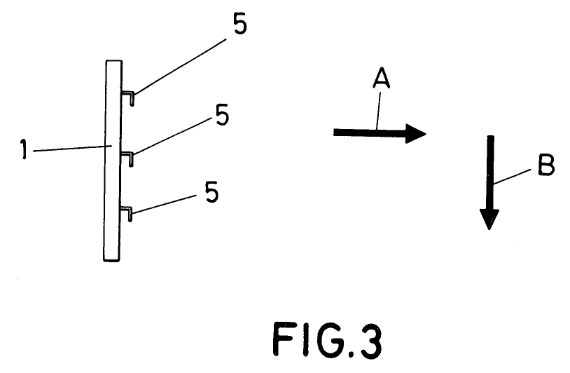

The door part is provided with a plurality of holes 4 which constitute attachment means supplementary to other attachment means 5 associated with a trim panel illustrated diagrammatically in FIG. 2. These attachment means 5 associated with the trim panel comprise hooks or inverted “L” shaped projections, with a first section which extends in a substantially perpendicular way in relation to the surface of the trim panel 1, and a second section which descends in a substantially parallel way to said surface. FIG. 3 illustrates diagrammatically a cross section of the trim panel, with these hooks.

To couple and hitch the trim panel 1 to the door part 22, a first movement “A” of approach is executed, as illustrated diagrammatically in FIG. 3, between the trim panel 1 and the door part up to a first position of the trim panel in relation to the door part, in which the trim panel is practically up against the door part and in which the hooks 5 pass through the holes 4 in the door part. This first movement is followed by a second hitching movement “B” up to a second position of the trim panel in relation to the door part, in which said trim panel 1 is hitched to the door part 22 by means of said hooks 5, which will rest on the surface of the door part opposed to the surface on which the trim panel is attached. The second movement B has a direction substantially perpendicular to the direction of the first movement A. In other words, the concept of union is based on hitching starting from a movement of approach (in a direction substantially perpendicular to the contact surface) followed by the hitching proper by means of a movement substantially parallel to the contact surface between the two pieces which are hitched together (namely, the trim panel and the door part).

As stated above, the latch is mounted on the door part 22. FIG. 2 illustrates the latch 3 in the position that it will occupy in relation to the trim panel once the trim panel is attached to the door part (FIG. 2 illustrates the non-visible face of the trim panel).

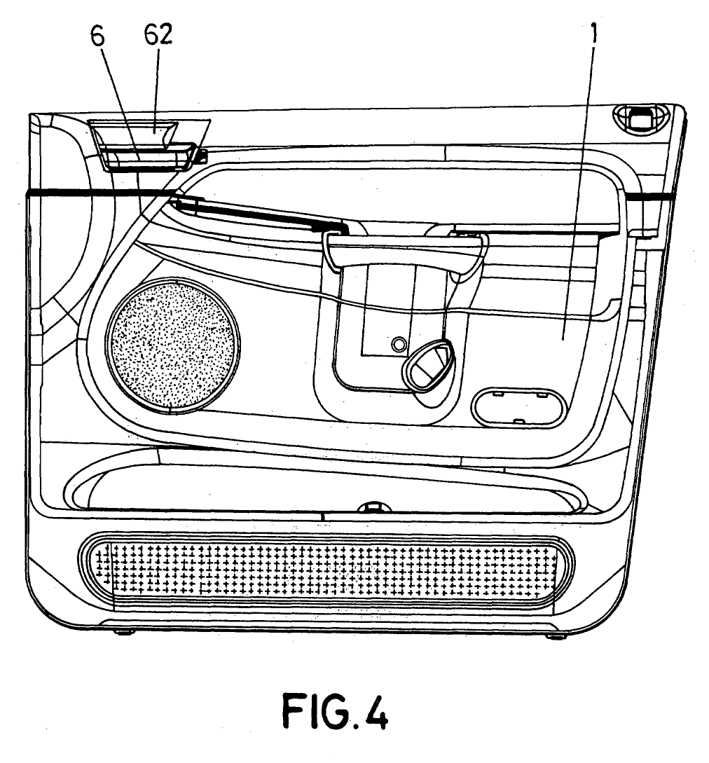

FIG. 4 illustrates diagrammatically the opening handle 6 pre-installed on the trim panel (FIG. 4 illustrates the visible side of the trim panel). The opening handle 6 forms part of a handle module 62, which may be seen in FIGS. 2 and 4. FIGS. 1 and 2 also illustrate diagrammatically a number of elements (8, 9, 81, 82, 83) that are used for connecting the opening handle 6 to the latch 3 (in FIG. 2, these elements are not connected to the trim panel but illustrated just to show the position they will occupy once the trim panel has been hitched to the door part).

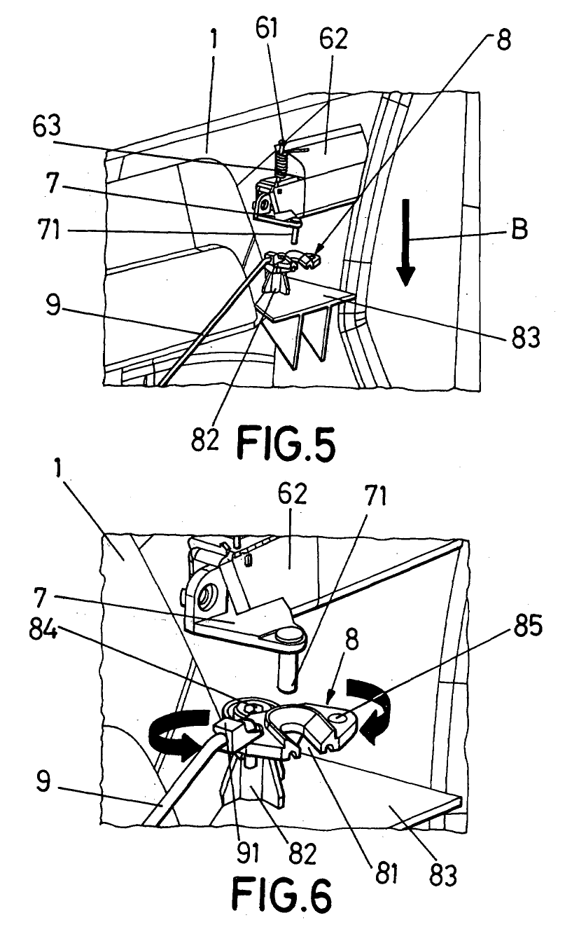

This system of connection between the latch 3 and the opening handle 6 is illustrated in greater detail in FIGS. 5-7. Basically, the connection system comprises a first pivotable element 7 associated with the opening handle 6 in such a way that it may pivot with the opening handle, and with a second pivotable element 8 attached to a rod 9, which connects this second pivotable element 8 to the latch 3, so that the angular position of the second pivotable element 8 (basically consisting of a pivotable pawl) determines whether the latch is open or not (see also FIGS. 1 and 2). This rod 9 may be a rigid element but there is also the possibility of implementing it with a cable or flexible rod.

The first pivotable element 7 comprises a moving support which forms an integral part of the handle 6 and which pivots around the same axis 61 as the handle, so that the actuation of the handle 6 is translated directly into a pivoting of said moving support. Both this support and the opening handle 6 and the axis 61 form part of the handle module 62, which is pre-installed on the trim panel. The moving support has a hole in which a stem or pin 71 is threaded (in an alternative embodiment, this projecting part may form part of the moving support, so that both elements make up a single metal or plastic piece).

Furthermore, the connection system comprises a bracket or support plate 83 (which, in FIG. 1, is hitched to the door part 22 by means of hooks and a screw which are coupled in holes 221 in the panel; in the event of the door part comprising a modular support, this bracket or support plate may form part of the modular support and be produced together with the modular support in a single mould). A turret 82 extends from this support plate. The support plate may have any type of appropriate configuration and it is attached to the door part; FIGS. 5-7 show the positions that the support plate and the elements associated with it will occupy in relation to the trim panel 1 during the installation process.

The second pivotable element 8 (which may be metal or plastic, for instance) is attached to the turret 82 by means of a screw 84, so that the second pivotable element 8 may pivot around a axis determined by said screw. The second pivotable element 8 has two holes 85 in which the rod 9 may be coupled (the rod is coupled in one of said holes, but the fact of having two holes means that the same pivotable piece may be used for either left-hand or right-hand doors). If the rod 9 and the second pivotable element 8 are both metal, an intermediate piece 91 may be used (see FIG. 6) of a non-metallic material, which, besides permitting the union between the two elements also serves to prevent direct contact between metal surfaces. In FIG. 6 we may observe how the second pivotable element can pivot.

This second pivotable element has an open funnel-shaped inlet channel or hole 81 (due to its chamfered upper edges), configured to permit the stem 71 to engage in said hole 81. In other words, the second pivotable element 8 forms a pawl which cooperates with the first pivotable element 7 by means of the coupling of the stem 71 in the hole 81.

Specifically, FIGS. 5 and 6 illustrate the relative position between the elements of the connecting system when the trim panel is in the first position, i.e. after movement “A” illustrated in FIG. 4 but before movement “B”. In this position, the stem 71 is situated above the channel 81 (supposing that the door part 22 and the trim panel 1 are in the vertical position). After movement “B” (shown as vertical in FIG. 5), i.e. when the hitching takes place between the trim panel and the door part, the elements of the connection system occupy the position illustrated in FIG. 7, in which the stem 71 is housed in the channel or hole 81, so that when the opening handle 6 is operated, this causes the moving support 7 to turn together with its stem 71, drawing the pawl 8, which in turn draws the rod 9, thereby opening the latch. The handle module 62 may comprise a spring 63 which has the function of making the moving support 7 (and the opening handle 6) return to its home position when it ceases to act on the handle.

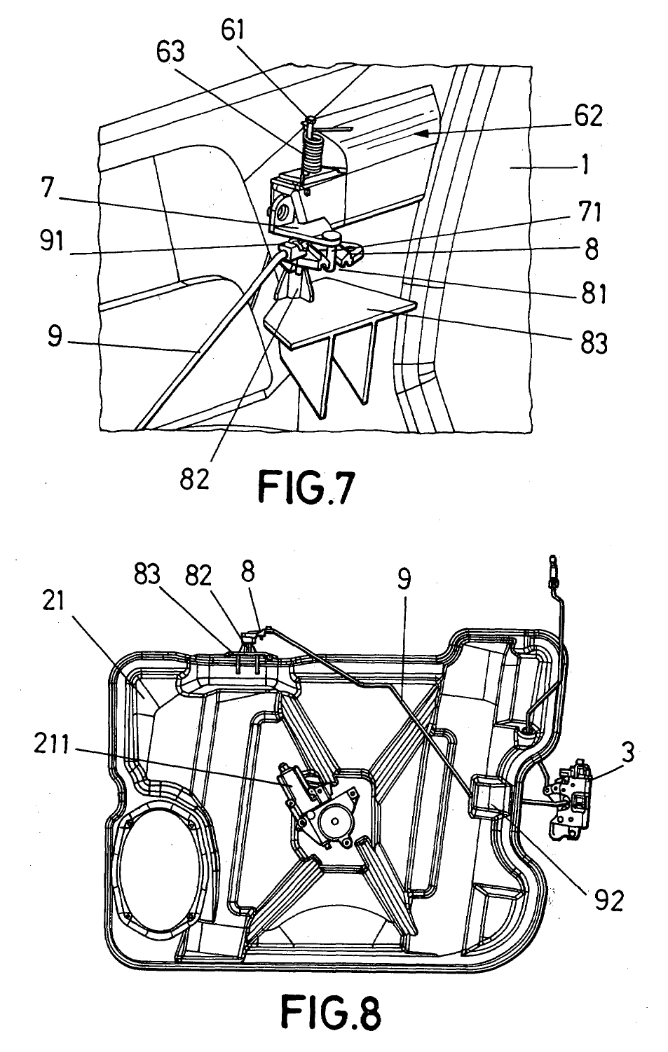

In an alternative embodiment of the invention, illustrated diagrammatically in FIG. 8, the latch (and other elements, such as for example a motor 211 for a window regulator system) is mounted on a modular support 21 which is connected to the door shell, so that said modular support serves to hold the latch and other elements in their respective positions before and during the installation, which facilitates this operation. Through being connected to the door panel or box, this modular support 21 may establish a sealed space in the direction of the interior of the vehicle. In FIG. 8 we may see how the modular support comprises a part 92 that forms a passage through which the rod 9 runs to the other side of the modular support.

In the event of this type of modular support being used, the door part comprises on the one hand the door shell, and, on the other, the modular support. The trim panel may be attached to the door part by means of hitching in holes 4 in the door shell and/or in holes in the modular support, so that the sealing function may be assured.

When a modular support is used, the part of the connection system between the opening handle 6 and the latch 3 not associated with the trim panel may be associated with the modular support 21, as illustrated diagrammatically in FIG. 8. In this case, the support plate 83 and the turret 82 may form part of the actual modular support (for example, so that they constitute a “single piece” with the rest of the modular support, a single piece produced by means of mould injection).

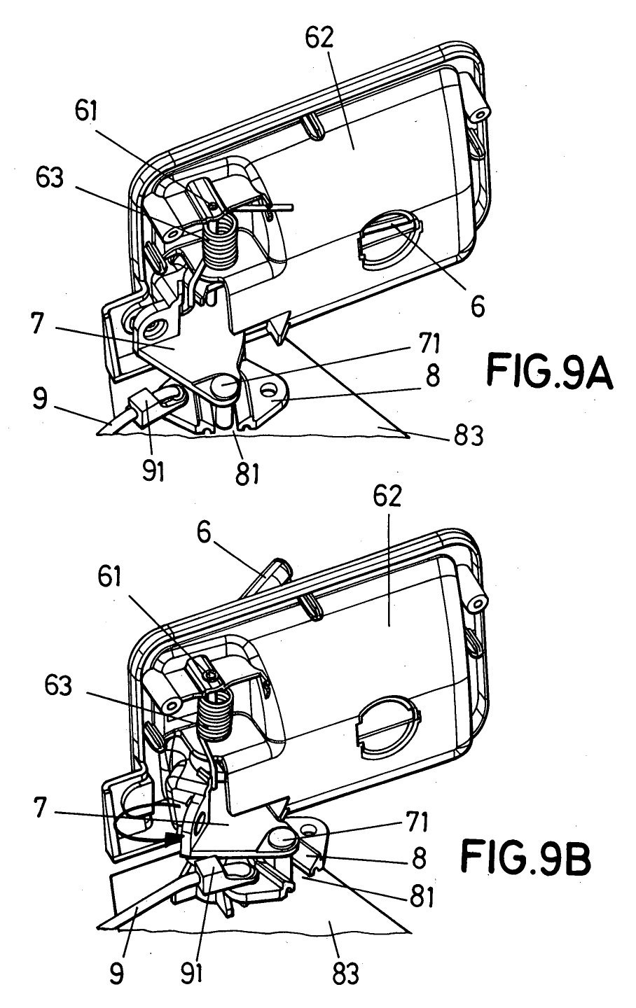

FIGS. 9A and 9B illustrate the connection system diagrammatically in two different positions. The position illustrated in FIG. 9A, with the opening handle up again the wall of the handle module 62, corresponds to a closed state of the latch. The position illustrated in FIG. 9B, in which the handle has been turned towards “the interior” of the vehicle, corresponds to an open position of the latch. The turning of the handle has caused the swelling of the first pivotable element 7, which, via the stem 71 which engages in the groove or hole 81, has drawn the second pivotable element or “pawl” 8. This, in turn, has drawn the rod 9, thereby bringing about the opening of the latch).

In this text, the word “comprises” and its variants (such as “comprising”, etc.) should not be interpreted in an exclusive manner, i.e. they do not preclude the possibility that what is described may include other elements, steps, etc.

Furthermore, the invention is not restricted to the specific embodiments that have been described, but also encompasses, for instance, the variants that may be executed by the average expert on the matter (for example, with regard to the choice of materials, dimensions, components, configuration, etc.), within the scope of what may be deduced from the claims.

1. Door assembly for a vehicle, which comprises:
a door part;
a trim panel configured to be attached to the door part by way of attachment means, said attachment means being configured so that the attachment between the trim panel and the door part is brought about by means of a first movement (A), said movement being an approach movement between the trim panel and the door part up to a first position of the trim panel in relation to the door part, and a second hitching movement (B) up to a second position of the trim panel in relation to the door part, in which said trim panel is hitched to the door part by means of said attachment means, said first movement having a first direction and said second movement having a second direction substantially perpendicular to said first direction;
a latch coupled to the door part;
an opening handle coupled to the trim panel;
a connection system between the opening handle and the latch, configured so that the latch can be opened by means of the opening handle;
characterised in that
said connection system comprises
a first pivotable element associated with the opening handle, so that, by means of a movement of the opening handle, the first pivotable element can be made to pivot;
a second pivotable element associated with the door part and coupled to the latch, so that the latch can be opened by means of a pivoting of the second pivotable element;
coupling means between said first pivotable element and said second pivotable element configured in such a way that, when the trim panel is in said first position, the first pivotable element and the second pivotable element are not coupled to each other, and when the trim panel is in said second position, the first pivotable element and the second pivotable element are coupled to each other in such a way that a pivoting of the first pivotable element causes the second pivotable element to pivot.

2. Assembly according to claim 1, in which said coupling means comprise a projecting element associated with one of said first pivotable element and second pivotable element, configured so as to enter into a receiving configuration in the other of said first pivotable element and second pivotable element.

3. Assembly according to claim 2, in which said projecting element is a stem.

4. Assembly according to either of claim 2, in which said receiving configuration is a hole or channel.

5. Assembly according to claim 2, in which the receiving configuration has a funnel-shaped form so as to facilitate the insertion of the projecting element in the receiving configuration during the second movement (B).

6. Assembly according to claim 2, in which said projecting element comprises a stem threaded into a pivoting support.

7. Assembly according to claim 2, in which said projecting element is an extension of a pivoting support, in such a way that the pivoting support, including said projecting element, forms a single plastic or metal piece.

8. Assembly according to claim 2, in which the projecting element forms part of the first pivotable element and in which the receiving configuration forms part of the second pivotable element.

9. Assembly according to claim 1, in which the second pivotable element is coupled to the latch by means of at least one rod or cable.

10. Assembly according to claim 9, in which the second pivotable element comprises two connecting holes for said rod, such that said rod may be connected selectively to one of said connecting holes or the other, depending on whether it is the case of a left-hand or a right-hand door of the vehicle.

11. Assembly according to claim 1, in which the first pivotable element comprises a moveable plate which forms part of a single piece which includes the handle and which is installed in a pivotable manner around an axis.

12. Assembly according to claim 1, in which the second pivotable element is mounted on a turret.

13. Assembly according to claim 12, in which said turret extends from a support plate attached to the door part.

14. Assembly according to claim 12, in which the second pivotable element is attached to said turret by means of a screw.

15. Assembly according to claim 1, in which the first pivotable element is configured to pivot around a first axis, and in which the second pivotable element is configured to pivot around a second axis, parallel to the first axis.

16. Assembly according to claim 15, in which said second direction in which the trim panel moves is parallel to said first axis and to said second axis.

17. Assembly according to claim 1, in which said second direction is substantially parallel to a general contact surface between the trim panel and the door part.

18. Assembly according to claim 1, characterised in that the door part consists of a door shell.

19. Assembly according to claim 1, characterised in that the door part comprises a modular support attached to a door shell.

20. Assembly according to claim 1, characterised in that said attachment means comprise a plurality of projections on the trim panel and holes in the door part, said projections comprising a first part substantially perpendicular to a surface of the trim panel, and a second part substantially parallel to said surface of the trim panel.

21. A vehicle door, which comprises an assembly according to claim 1.

22. Method of assembling a door for a vehicle on the basis of an assembly according to claim 1, which comprises the following steps:
bringing the trim panel up to the door part, by means of said first movement (A) in said first direction;
hitching the trim panel to the door part by means of said second movement (B) in said second direction substantially perpendicular to said first position, in such a way that a coupling takes place between said first pivotable element and said second pivotable element.
